(19) United States
(12) Patent Application Publication
(10) Pub. No.: US 2002/0031298 A1
(43) Pub. Date: Mar. 14, 2002

(54) Array light source

(76) Inventor: Akiyoshi Hamada, Osaka (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/855,843

(22) Filed: May 16, 2001

(30) Foreign Application Priority Data
May 16, 2000 (JP) 2000-142687

(51) Int. Cl. G02B 6/26

(52) U.S. Cl. 385/31

(57) ABSTRACT

An array light source that emits laser beams including an optical waiveguide or optical fibers formed as the light source. The array light source has, for example, an array portion having exit ends disposed in an array, and each emitting a laser beam. The array also has a flat plate having light transmittivity and is provided with a positioning and fixing surface. The exit ends of the array portion are fixed to the positioning and fixing surface of the flat plate by an adhesive having light transmittivity.

### RELATED APPLICATION

This application is based on application No. 2000-142687 filed in Japan, the content of which is hereby incorporated by reference.

### TECHNICAL FIELD OF THE INVENTION

The present invention relates to an array light source that emits a plurality of laser beams, and more specifically, to an array light source comprising optical waveguides or optical fibers and formed particularly as a light source of a laser beam scanner.

### BACKGROUND OF THE INVENTION

With recent development and digitization of information networks, output optical systems for information apparatuses, such as laser beam scanners, have increasingly been required to be faster. To increase the image formation speed of laser beam scanners photoconductor surfaces have been conventionally scanned with a plurality of laser beams. Specifically, the use of two beams in intermediate to high speed digital monochrome PPCs, laser beam printers, and digital color PPCs have been used. The use of a greater number of beams is expected in the near future.

As a means for realizing the use of a greater number of beams, a method has been considered of forming a so-called multi light source in which a plurality of laser light sources are arranged with fine pitches. Examples of this method include a method using a so-called array laser in which a plurality of laser diodes are formed on a substrate as the laser light sources, a method using as a secondary light source light having exited from optical fibers bundled in an array, and a method using optical waveguides arranged in an array so that the pitch decreases from the incident side to the exit side.

By adopting such an array light source, the light source is compact, cost reduction by mass production is achieved, and the optical system disposed in the rear of the light source can be simplified. The array light source is considered to be the mainstream of the light source of the laser beam scanner in the figures.

Conventionally, a method has been proposed of fixing an array light source to a sub mount at a surface parallel to the direction of travel of the exiting laser beams, for example, as described in Japanese Laid-open Patent Application No. H11-271752.

However, in the structure as described in Japanese Laid-open Patent Application No. H11-271752, there are cases where the light source unit is deformed by a stress applied when the array light source is fixed. In addition, in an array light source comprising optical fibers, when ends of the optical fibers are cut in order to achieve a required position accuracy of the laser beam exit surface, the end surface is easily scratched.

### SUMMARY OF THE INVENTION

In one embodiment of the present invention, there is a system and method to provide an array light source to position a the laser beam exit position, without compactness deteriorating, by the same positioning and fixing technology that is used for normal optical parts.

The array light source includes, for example, an array portion having exit ends disposed in an array and each independently emitting a laser beam and a flat plate having light transmittivity and provided with a positioning and fixing surface. The exit ends of the array portion are fixed to the positioning and fixing surface of the flat plate by an adhesive having light transmittivity.

### BRIEF DESCRIPTION OF THE DRAWINGS

This and other features of the invention will become clear from the following description, taken in conjunction with the preferred embodiments with reference to the accompanied drawings in which:

FIG. 1 is a perspective view showing an example of the optical system of a laser beam scanner using the array light source of the present invention;

FIG. 2 is a perspective view showing another example of the optical system of a laser beam scanner using the array light source of the present invention;

FIG. 3 is a perspective view showing an example of the array portion used in the present invention;

FIG. 4 is a perspective view showing another example of the basic structure of the array portion used in the present invention;

FIG. 5 is a longitudinal sectional view schematically showing an array light source according to a first embodiment of the present invention;

FIG. 6 is a longitudinal sectional view schematically showing an array light source according to a second embodiment of the present invention; and

FIG. 7 is a perspective view showing another example of positioning and fixing of the array light source of the present invention.

### DETAILED DESCRIPTION OF THE INVENTION

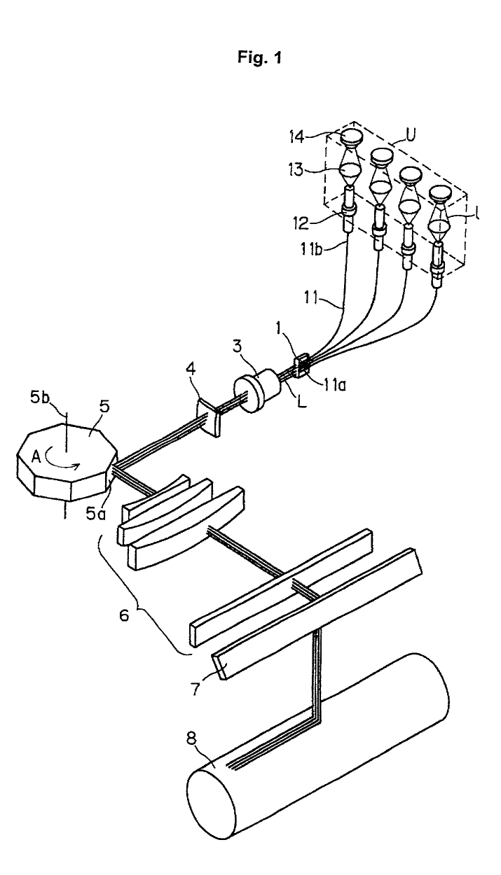

Embodiments of the present invention will be described with reference to the drawings. FIG. 1 is a perspective view showing an example of the optical system of a laser beam scanner using the array light source of the present invention. As shown in FIG. 1, a multi-fiber array 1 is used as the laser light source which is an array light source. In the multi-fiber array 1, ends (exit ends) 11a of a plurality of optical fibers 11 are arranged in an array. A substantially cylindrical ferrule 12 is provided at each of the other ends (incident ends) 11b of the optical fibers 11. The ferrules 12 are each associated with a laser diode 14 through a coupling lens 13, which are disposed in an LD coupling unit U shown by the broken lines.

The exit beams 1 from the laser diodes 14 are condensed by the coupling lens 13 and incident from the ferrules 12 on the other ends 11b of the optical fibers 11. The exit beams 1 pass through the optical fibers 11, and at the multi-fiber array 1, exits from the ends 11a of the optical fibers 11 as a plurality of laser beams L.

The laser beams L having exited from the multi-fiber array 1 pass through a collimator lens 3 to be collimated, pass through a cylinder lens 4 to be condensed in the sub scanning direction in the vicinity of a surface 5a of a polygonal mirror 5. The laser beams L are then deflected by the polygonal mirror 5, which rotates on the rotation axis 5b in the direction of the arrow A. Then, the laser beams L are refracted by a scanning lens 6, reflected by a bending mirror 7, and condensed on a photoconductor drum 8 to form a plurality of lines (latent images). The rotation of the polygonal mirror 5 rotates the surfaces 5a, so that the laser beams L scan the surface of the rotating photoconductor drum 8 to form the latent images.

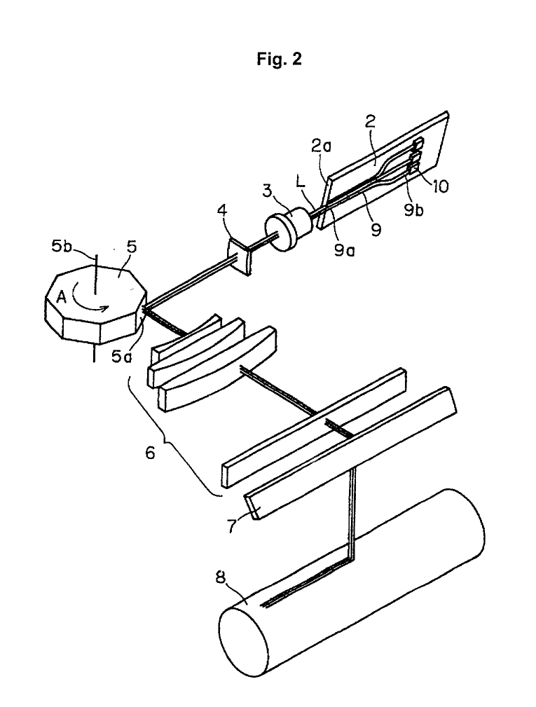

FIG. 2 is a perspective view showing another example of the optical system of a laser beam scanner using the array light source of the present invention. As shown in the FIG. 2, a waveguide array light source 2 is used as the laser light source which is an array light source. At an end 2a of the waveguide array light source 2, ends (exit ends) 9a of a plurality of waveguides 9 are arranged in an array. At each of the other ends (incident ends) 9b of the waveguides 9, a laser diode 10 is provided. The exit beams from the laser diodes 10 are incident on the other ends 9b of the waveguides 9. The exit beams pass through the waveguides 9, at the end 2a of the waveguide array light source 2, and exit from the ends 9a of the waveguides 9 as a plurality of laser beams L.

The laser beams L having exited from the waveguide array light source 2 pass through a collimator lens 3 to be collimated. The laser beams L then pass through a cylinder lens 4 to be condensed in the sub scanning direction in the vicinity of a surface 5a of a polygonal mirror 5, and are then deflected by the polygonal mirror 5 rotating on the rotation axis 5b in the direction of the arrow A. Then, the laser beams L are refracted by a scanning lens 6, reflected by a bending mirror 7, and condensed on a photoconductor drum 8 to form a plurality of lines (latent images). The rotation of the polygonal mirror 5 rotates the surfaces 5a, so that the laser beams L scan the surface of the rotating photoconductor drum 8 to form the latent images.

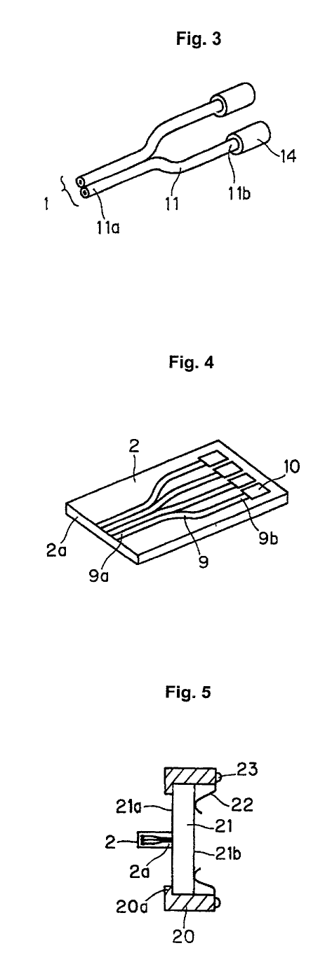

FIG. 3 is a perspective view showing an example of the array portion used in the present invention. In this example, the array portion comprises optical fibers. As shown in FIG. 3, the ends (exit ends) la of the optical fibers 11 are arranged in an array. This structure is the above-described multi-fiber array 1. At each of the other ends (incident ends) 11b of the optical fibers 11, the laser diode 14 is provided. In FIG. 3, the coupling structure, such as the above-mentioned ferrule, is not shown. The exit beams from the laser diodes 14 are incident on the other ends 11b of the optical fibers 11. Then, the exit beams pass through the optical fibers 11, and exit from the ends 11a as a plurality of laser beams.

FIG. 4 is a perspective view showing another example of the basic structure of the array portion used in the present invention. In this example, the array portion comprises waveguides. As shown in FIG. 4, the ends (exit ends) 9a of a plurality of waveguides 9 are arranged in an array at the end 2a of the waveguide array light source 2. At each of the other ends (incident ends) 9b of the waveguides 9, the laser diode 10 is provided. The exit beams from the laser diodes 10 are incident on the other ends 9b of the waveguides 9. The exit beams pass through the waveguides 9, and at the end 2a of the waveguide array light source 2, exit from the ends 9a of the waveguides 9 as a plurality of laser beams. Generally, a waveguide array light source is as small as, for example, 3 mm in width, 10 mm in length and 0.4 mm in thickness.

FIG. 5 is a longitudinal sectional view schematically showing an array light source according to a first embodiment of the present invention. In this embodiment, as shown in the FIG. 5, a disk-form flat plate 21 made of a material such as glass and having light transmittivity is fitted in a fixed cylinder 20. A positioning surface 21a of the flat plate 21 abuts on a ring-shaped protrusion 20a inwardly protruding from the inner surface at an end of the fixed cylinder 20. To the other end of the fixed cylinder 20, a plate spring 22 is fixed by a screw 23. The plate spring 22 presses a pressed surface 21b of the flat plate 21 to press the positioning surface 21a on the opposite side against the protrusion 20a, thereby fixing the flat plate 21 to the fixed cylinder 20.

To the positioning surface 21a, the above-described waveguide array light source 2 is bonded at the end 2a by an adhesive having light transmittivity. The waveguide array light source 2 is disposed in the optical system of a laser scanner as shown in FIG. 2. At this time, the fixed cylinder 20 in which the flat plate 21 having the waveguide array light source 2 bonded thereto is fitted is positioned and fixed to the optical system of the laser scanner (not shown).

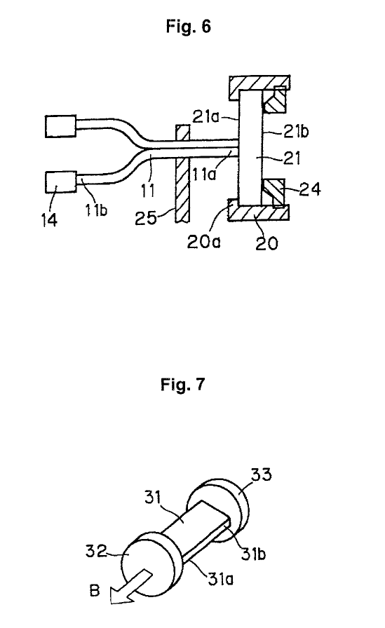

FIG. 6 is a longitudinal sectional view schematically showing an array light source according to a second embodiment of the present invention. In this embodiment, as shown in FIG. 6, a disk-form flat plate 21 made of a material such as glass and having light transmittivity is fitted in a fixed cylinder 20 like FIG. 5. A positioning surface 21a of the flat plate 21 abuts on a ring-shaped protrusion 20a inwardly protruding from the inner surface at an end of the fixed cylinder 20. At the other end of the fixed cylinder 20, a flat fixing ring 24 is screwed in. The flat fixing ring 24 presses a pressed surface 21b of the flat plate 21 to press the positioning surface 21a on the opposite side against the protrusion 20a, thereby fixing the flat plate 21 to the fixed cylinder 20.

To the positioning surface 21a, the above-described optical fibers 11 constituting the multi-fiber array 1 are bonded at the ends 11a by an adhesive having light transmittivity. The optical fibers 11 are disposed in the optical system of a laser scanner as shown in FIG. 1. At this time, the fixed cylinder 20, in which the flat plate 21 having the optical fibers 11 bonded thereto, is fitted is positioned and fixed to the optical system of the laser scanner (not shown). Moreover, by disposing a support member 25 in a position closer to the center than the ends 11a of the optical fibers 11 are, the optical fibers 11 are prevented from warping, and no stress is applied to the portion where the optical fibers 11 are bonded to the positioning surface 21a.

The examples shown in FIGS. 5 and 6 may employ either of the structure shown in FIG. 5 in which the flat plate 21 is pressed by the plate spring 22 and the structure shown in FIG. 6 in which the flat plate 21 is pressed by the flat fixing ring 24.

FIG. 7 is a perspective view showing another example of positioning and fixing of the array light source of the present invention. When the array light source is large in front-to-rear length or heavy, and a stress is caused by the influence of the length or the weight so that the adhesion of the exit end to the flat plate is relatively weak, a support is additionally provided for the array light source. That is, as shown in FIG. 7, an array light source 31 is bonded at an end (exit end) 31a to a disk-form flat plate 32 for positioning and bonded at the other end 31b by a flat plate 33 for supporting. The plate 32 is made of a material such as glass and has light transmittivity. Similarly, the adhesive used for bonding also has light transmittivity.

The flat plates 32 and 33 are both fixed to one fixed cylinder (non-illustrated) by being fitted therein. The succeeding process is similar to that in the case of the fixed cylinder 20 of FIGS. 5 and 6. Alternatively, the flat plates 32 and 33 may separately be positioned and fixed to the optical system of the laser scanner. It is unnecessary for the flat plate 33 and the adhesive used in this example to have light transmittivity. The arrow B represents the laser beam exit direction. It is not always necessary for the flat plates with light transmittivity having been described in this specification to have a disk form.

As described above, in the array light source of the present invention, a flat plate having light transmittivity is bonded to the laser beam exit end surface by an adhesive having light transmittivity, and the flat plate is positioned and fixed to the optical system disposed in the rear thereof.

Conventional lens fixing technology can be used when a flat plate of a freely selected size can be positioned and fixed. For example, when a disk-form flat plate is used, similar to a lens barrel. In this case, positioning with respect to the optical system disposed in the rear of the array light source can smoothly be performed. Even when the flat plate is fixed by pressure application, since no pressure is directly applied to the optical fibers or the optical waveguides bonded to the flat plate, the optical fibers or the optical waveguides are hardly deformed, so that the laser beams passing therethrough are hardly affected.

It is known that when a stress vertical to the light guided direction is applied to the optical fibers or the optical waveguides, fluctuations are caused in the polarization components of the laser beams passing through and exiting from the optical fibers or the optical waveguides. According to the present invention, since a stress is applied only to an extremely small area in the vicinity of the bonded exit end surface, the influence of the stress is extremely small compared to the conventional method of fixing the array light source at a surface parallel to the light guided direction.

Even when there are a few scratches on the exit end surface, since an adhesive is filled between the exit end surface and the flat plate, the detrimental effect of the scratches on the laser beams is extremely small by the refractive index difference between the adhesive and the array light source being small.

As described above, according to the present invention, an array light source can be provided capable of highly and accurately positioning the laser beam exit position without compactness deteriorating, by the same positioning and fixing technology that is used for normal optical parts. Moreover, the effect of positioning lasts semipermanently.

Although the present invention has been fully described by way of example with reference to the accompanying drawings, it is to be understood that various changes and modifications will be apparent to those skilled in the art. Therefore, unless otherwise such changes and modification depart from the scope of the present invention, they should be construed as being included therein.

What is claimed is:

1. An array light source to position a laser beam exit position, the array light source comprising:
an array portion having exit ends disposed in an array, each independently emitting a laser beam; and
a flat plate having light transmittivity and provided with a positioning and fixing surface.

2. The array light source of claim 1, wherein the exit ends of the array portion are fixed to the positioning and fixing surface of the flat plate by an adhesive having light transmittivity.

3. The array light source of claim 1, wherein the array light source includes waiveguides arranged in an array.

4. The array light source of claim 1, wherein the array light source includes optical fibers arranged in an array.

5. A laser beam printer having an array light source, the array light source comprising:
an array portion having exit ends disposed in an array, each independently emitting laser beams; and
a flat plate having light transmittivity and provided with a positioning and fixing surface.

6. The laser beam printer of claim 5, wherein the emitted laser beams are parallel and in the same plane.

7. The laser beam printer of claim 5, wherein the emitted laser beams are parallel to a sub-scanning direction.

8. An array light source, comprising:
a flat plate having a light transmittivity fitted in a cylinder; and
a positioning surface of the flat plate abutting a ring-shaped protrusion and inwardly protruding from the inner surface at an end of the cylinder.

9. The array light source of claim 8, further comprising:
a plate spring fixed to the other end of the cylinder and pressing against a pressed surface of the flat plate to position the positioning surface on the opposite side of the protrusion, thereby fixing the flat plate to the cylinder.

10. The array light source of claim 8, wherein the flat plate is in the shape of a disk-form and made of glass, and the array light source comprises a plurality of waiveguides.

11. The array light source of claim 8, wherein the array light source includes a plurality of waiveguides that are bonded at and end of the of the waiveguides to the flat plate by an adhesive.

12. The array light source of claim 8, further comprising:
optical fibers including a multi-fiber array are bonded by an adhesive, having light transmittivity, to the flat plate.

11. The array light source of claim 11, further comprising:
a support member to support the optical fibers such that warping and stress is prevented to the optical fibers at a location of bonding.

13. A laser beam scanning system, comprising:
an array light source having a plurality of optical fibers and a flat plate having a light transmittivity fitted in a cylinder, wherein ends of the optical fibers are arranged in an array.

14. The system of claim 13, wherein the array light source includes a positioning surface of the flat plate abutting a ring-shaped protrusion and inwardly protruding from the inner surface at an end of the cylinder.

15. The system of claim 13, further comprising:
laser beams exiting from the optical fibers;
a collimator lens to collimate the laser beams;
a cylinder lens to condense, in a sub-scanning direction, the laser beams;
a mirror deflecting and rotating, in a rotation axis, the laser beams in the direction of arrow A;
a scanning lens to refract the laser beams reflected by a bending mirror; and
a photocondutor drum to condense the laser beams to form a plurality of lines forming images.
